(19) United States
(12) Patent Application Publication
(10) Pub. No.: US 2005/0138564 A1
(43) Pub. Date: Jun. 23, 2005

(54) Visualization of a significance of a set of individual elements about a focal point on a user interface

(76) Inventor: Brian J. Fogg, Stanford, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/740,361

(22) Filed: Dec. 17, 2003

(51) Int. Cl. G06F 3/00; G06F 17/21

(52) U.S. Cl. 715/745; 715/810; 715/811; 715/836; 715/837; 715/838; 715/839; 715/840; 715/841; 715/804; 715/805; 715/846; 715/847; 715/848; 715/849; 715/850; 715/851; 715/852; 715/853; 715/854; 715/855; 715/713; 715/513; 715/501.1

(57) ABSTRACT

A user interface having a focal point and reference icons is described. In one embodiment of the invention, the reference icons represent individual elements, such as elements of an ordered list. The reference icons are positioned radially about the focal point on the user interface to visualize the significance of each individual element.

### CROSS-REFERENCE TO RELATED APPLICATIONS

This application is related to copending patent application Ser. No. 10/659,580, entitled “Relationship User Interface,” filed Sep. 9, 2003.

### COPYRIGHT NOTICE/PERMISSION

A portion of the disclosure of this patent document contains material, which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright©2003, B. J. Fogg, All Rights Reserved.

### TECHNICAL FIELD

Embodiments of the invention relate to the field of computing and, more specifically, to visualization of a significance of a set of individual elements about a focal point on a user interface.

### BACKGROUND

A simple list, such as a shopping list (e.g., a list of items to be bought), a task list (e.g., a list of tasks a person wants to accomplish), and a top ten list (e.g., a travel magazine may publish a list of the top ten most beautiful hotels in an ordered list) have been used to visualize the importance of an item. These lists may be in a specific order and are visualized in a horizontal or vertical fashion.

However, the viewing of a list on a computing device is not visually appealing to a user. Traditional lists are not cognitively efficient and the simple ordering does not convey rich information about the items in the list. For example, a traditional list of messages in an email inbox conveys only one type of information, such as when the messages were received relative to each other. Web search engines also use traditional lists. For example, a user may provide a search engine a search criteria, such as to search for real estate agents in San Francisco, Calif. In return, the search engine may provide the user a list of web pages associated with real estate agents in San Francisco, Calif. At times, the list of web pages are listed in a specific order based on relevancy determined by the search engine provider.

Depending on the number of search results, the user may have to scroll up and down the list to view the entire list of web pages. In addition, the user may also have to move through multiple pages to view the entire list of search results if the list of web pages cannot be displayed on a single page. Accordingly, the viewing of a list on a web page may be very time-consuming and burdensome to the user, especially when viewing the list on smaller displays, such as on mobile devices (e.g., mobile personal computers, personal digital assistants, mobile phones, etc.).

### BRIEF SUMMARY OF AN EMBODIMENT OF THE INVENTION

A user interface having a focal point and reference icons is described. In one embodiment of the invention, the reference icons represent individual elements, such as elements of an ordered list. The reference icons are positioned radially about the focal point on the user interface to visualize the significance of each individual element.

### BRIEF DESCRIPTION OF THE DRAWINGS

The invention may best be understood by referring to the following description and accompanying drawings that are used to illustrate embodiments of the invention.

FIG. 1A illustrates one embodiment of a user interface on a computer system having a focal point and reference icons.

FIG. 1B illustrates one embodiment the user interface displaying a X-axis and a Y-axis.

FIG. 2 illustrates one embodiment of a process flow for visualizing individual elements of interest.

FIG. 3 illustrates one embodiment of a reference profile.

FIG. 4 illustrates an exemplary computer system according to one embodiment of the invention.

FIG. 5 illustrates a network environment suitable for the computer system illustrated in FIG. 4.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description.

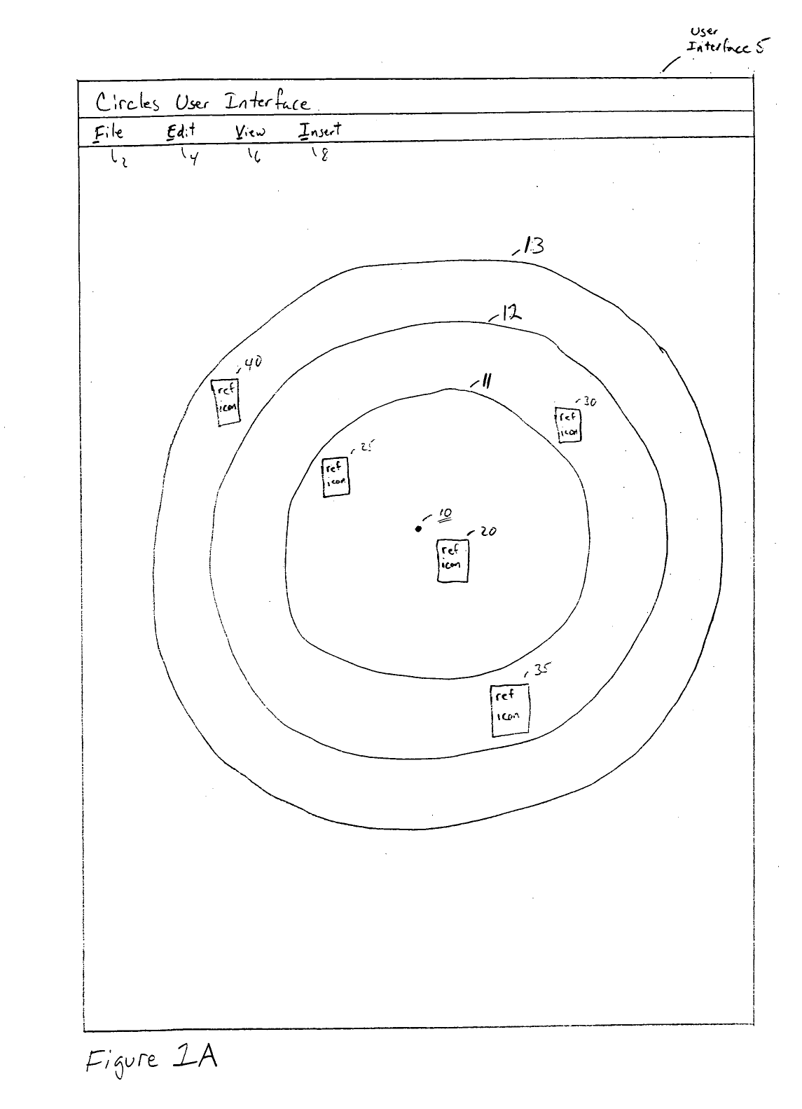

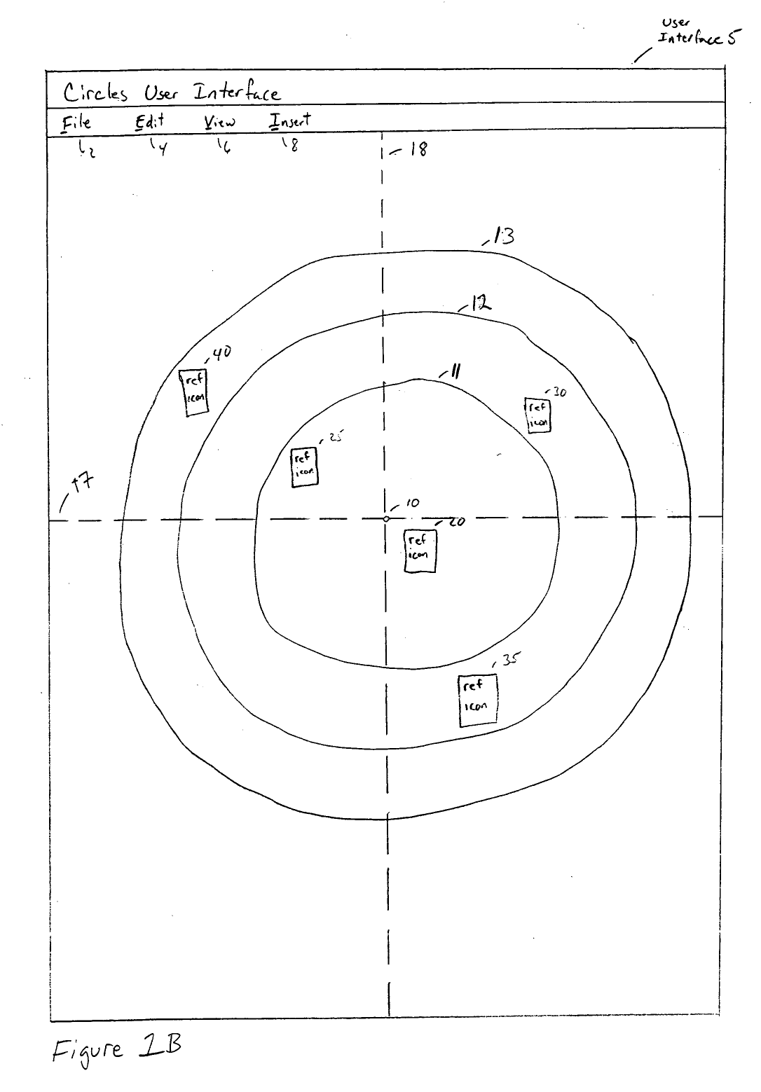

A user interface having a focal point and one or more reference icons to visualize individual elements of interest to a user is described. According to one embodiment of the invention, the user interface visualizes a significance of the individual elements of interest to the user as will be described below. FIG. 1A illustrates one embodiment of a user interface 5 on a computer system. The user interface 5 includes focal point 10, rings 11-13, and reference icons 20-40 (e.g., reference icon 20, reference icon 25, reference icon 30, reference icon 35, and reference icon 40).

The focal point 10 is a reference point from which the reference icons 20-40 are radially positioned about on the user interface 5, as will be further described below. The focal point 10 may or may not be visible to the user. If the focal point 10 is visible, the focal point 10 may be represented by an icon, simple text, etc.

The reference icons 20-40 represent a set of individual elements of interest to the user. For example, the elements of interest may include references of restaurants, books, travel locations, music CDs, music singles, sport scores and information, video games, software applications, network page search result web pages, hotels, airline flights, gifts, television and cable programming, television and cable channels, homes for sale, dates, webpages, friends, experts, health insurance plans, news stories, car information, mutual funds, rental apartments, pets, sport teams, and celebrities among other examples.

In one embodiment, the closer a specific reference icon is positioned relative to the focal point 10, the more significant the reference icon 20-40 is to the user. For example, if the reference icons 20-40 represent a set of books, the books represented by reference icon 20 and reference icon 25 may be more interesting to the user or closer to a specified criteria (criteria can be specified by user or by third party or dynamically by software) than the books represented by reference icon 35 or reference icon 40. In addition, assuming the reference icons 20-40 represent books on a bestsellers list, the books that are positioned closer relative to the focal point 10 may represent the best selling books according to the best sellers list. In this way, the bestseller list is not displayed to the user as a vertical list on a web page that the user must scroll up and/or down to view. Rather, the bestseller list is displayed as reference icons radially positioned about the focal point based on the popularity of the book. The visual display of popular travel locations, video games, software applications, restaurants, etc. may also be viewed in this manner.

As for another example, the user interface 5 may communicate with a search engine to receive and display a search result as reference icons 20-40 about the focal point 10. Traditionally, a user receives web page search results in an ordered list that the user must scroll up and/or down to review, which may also be displayed on multiple pages. In contrast, the user interface 5 visualizes the search result with reference icons arranged radially about the focal point 10, where the most relevant web pages are positioned closer to the focal point 10. Performing a network search with a search engine is well known to those of ordinary skill in the art, and therefore is not shown in detail in order not to obscure the understanding of the description.

It should be understood that each reference icon 20-40 need not have a common relationship. For example, the reference icons 20-40 may represent individual tasks that the user wants to accomplish. Reference icon 20 may represent a reminder to take your daughter to soccer practice at 3 pm, reference icon 25 may represent a reminder to pick-up your dry cleaning, reference icon 30 may represent a reminder to attend a board meeting next month, and reference icon 40 may represent a reminder to pick up your mother-in-law from an airport at 5 pm, among other examples.

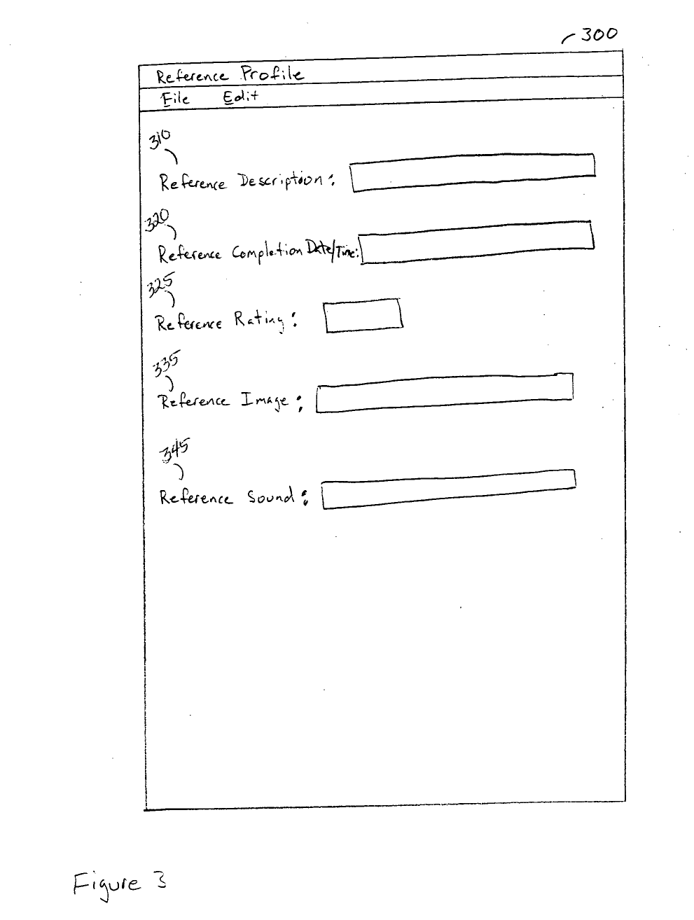

It should also be appreciated that the reference icons 20-40 may be arranged manually and/or automatically. For example, a user may manually insert and “drag and drop” a reference icon 20-40 to any position about the focal point 10 depending on whether the reference icon represents an interest of greater or lesser significance to the user. In addition, a new reference icon may be manually inserted onto the user interface 5 via a reference profile (as will be further described below in conjunction with FIG. 3), or by dragging items from another software application (e.g., such as dragging items from a web page or database).

Alternatively, the user interface 5 may automatically position the reference icons 20-40 about the focal point 10 based on predefined positioning criteria. For example, the user interface 5 may position reference icons representing web pages of a search result, where the predefined positioning criteria is based on the relevancy of each web page defined by a third party search engine. Predefined positioning criteria may also include ordered information, such as the order of a top ten list, ranking of sport teams, league standings of sport teams, an organizational structure of a business corporation, etc.

In one embodiment, the reference icons 20-40 may be re-arranged automatically based on a change in the pre-defined positioning criteria. For example, a reference icon representing a music CD associated with popular music may move closer to the focal point 10 if the music CD moves up the music charts. In one embodiment, as an appointed time to fulfill a task draws nearer, the related reference icon 20-40 will move closer relative to the focal point 10. Automatic rearrangement of the reference icons may be performed at any frequency of time including every second, minute, hour, day, week, etc. The reference icons may also shift automatically according to how often a user accesses the reference icon. For example, the reference icon for the CNN web site could move closer to the focal point automatically each time the user clicks on the CNN reference icon to access the site. On the other hand, if the user never clicks on the CNN icon, that icon can drift away from the focal point over time. The amount of use can be defined not only by frequency of access but by other criteria as well, such as length of time spent on the site, among other factors.

Referring again to FIG. 1A, the user interface 5 includes rings 11-13. The position of a reference icon 20-40 relative to one of the rings 11-13 may assist the user in visualizing the significance of a reference icon. For example, the significance of a reference icon may be represented with the more significant reference icons being within ring 11. Reference icons outside of the inner ring 11 are visualized having a lesser significance (e.g., the reference icons 20-40 that are positioned nearer to the outer ring 13). The user may also toggle the view of the rings 11-13 to be visible or to be hidden.

Additional visual aids might also be used to assist the user in visualizing the significance of a reference icon. FIG. 1B illustrates one embodiment the user interface 5 having a X-axis 17 and a Y-axis 18. For example, FIG. 1B may be used to assist the user of the user interface 5 to explore various treatments for cancer, in this case prescription medications and eastern herbs. Suppose that the X-axis 17 signifies effectiveness as shown by studies and the Y-axis 18 signifies how the American Medical Association (AMA) views the treatment. The more data the user accumulates indicating that the treatment works, the more the reference icon of that treatment migrates toward the right relative to the X-axis 17. The more data the user accumulates indicating that the treatment does not work, the more this reference icon gravitates toward the left relative to the X-axis 17. Furthermore, in relation to the Y-axis 18, if data is found indicating the treatment has approval of doctors, the related reference icon of the treatment migrates upward relative to the Y-axis 18. If doctors are skeptical, the related reference icon migrates down relative to the Y-axis.

Accordingly, reference icons positioned near the upper right hand corner signifies those treatment options having data indicating the treatment is effective and the AMA approves. The reference icons positioned in the lower left corner signify those treatment options having data indicating that they are effective but the AMA does not approve. Reference icons positioned near the focal point 10 may signify new treatments, treatments that do not include much data, or that the opinions are mixed.

In yet another example of the role of the x-axis 17 and y-axis 18, the user interface 5 may be used to represent a stock portfolio. In one embodiment, the more money the user (e.g., investor) has invested in a particular stock represented by the reference icons 20-40 (e.g., stock ticker symbols), the closer the related reference icon would be to the focal point 10. Furthermore, the color or size of each reference icon could show the net gain or loss for a specified time period, such as for the day, week, or month. The reference icon could also signify other information, such as how long the user has held the stock, etc. Other symbols associated with the reference icons 20-40 could represent a summary of expert views about the stock. In addition, the user interface 5 may enable the user to configure the dimensions for the X-axis 17 and the Y-axis 18 in order to get different perspectives of the portfolio, such as investment in small versus large cap companies, showing relative P/E ratios, and so on. In this way, the user is capable of switching through various criteria for the X-Y axes to visualize the various characteristics of the portfolio (e.g., small cap versus large, domestic vs. foreign, etc.).

One of ordinary skill in the art will recognize that the invention is not limited to the examples disclosed herein, and the reference icons 20-40 may represent numerous alternative people, entities, places, or things. Furthermore, the user interface 5 may include additional axes and/or may also be implemented in multiple dimensions (e.g., a three-dimensional space about a focal point) to, for example, visually indicate the significance of information. The invention is not limited only to the axis and dimensions shown herein.

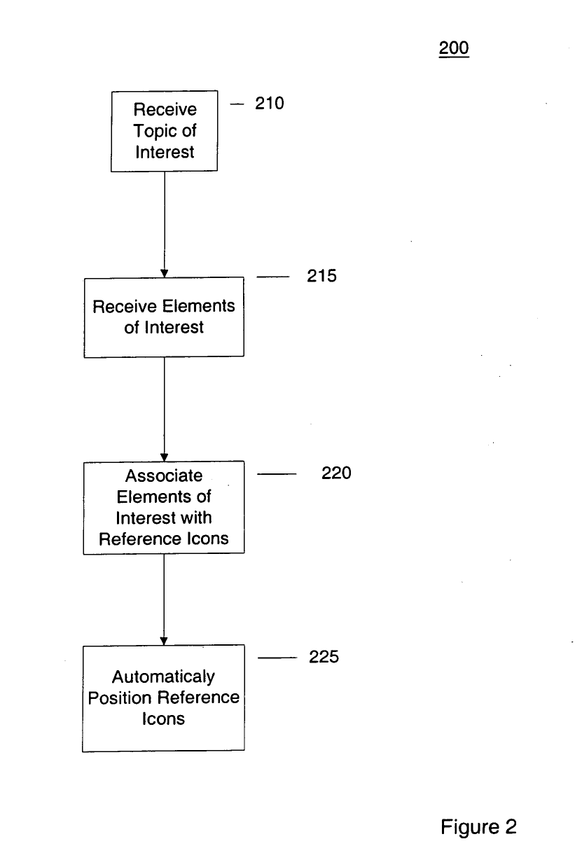

FIG. 2 illustrates one embodiment of a process flow 200 for visualizing individual elements of interest in a user interface on a device. The device may include any mechanism that includes a visual display interface including but not limited to a computer monitor, a television monitor, a hand-held device monitor (e.g., mobile phone LCD, a globe positioning receiver LCD etc.), etc.

At block 210, the device receives a topic of interest selected by the user. For example, the user may perform a search for restaurants based on search criteria such as a geographic location, a type of food, a price range, and a restaurant rating.

At block 215, the device receives the elements of interest. Continuing the example, a search result of restaurants ordered by relevancy given the search criteria is received by the user interface 5.

At block 220, the device associates the element of interest with a reference icon. Continuing the example, the device may associate a specific reference icon with a specific restaurant.

At block 225, the device automatically positions the reference icons on the user interface 5 about the focal point 10 based on the positioning criteria. Continuing the example, the device may position the reference icons associated with the restaurants on the user interface 5 based on the relevancy determined by the provider of the search results. If there are no positioning criteria, the device may position the reference icons at an equal distance about the focal point 10 on the user interface 5; or alternatively position the reference icons randomly about the focal point 10.

In one embodiment, the user interface 5 ensures the reference icons 20-40 are evenly spaced and balanced radially about the focal point 10 (including increasing and decreasing the size of the reference icons), thereby avoiding the overlaying of any reference icon. Factors used to determine the balanced arrangement of reference icons 20-40 might include the number of reference icons to be balanced and the number of pixels on the monitor output device, among other factors.

In one embodiment, the reference icons may exhibit specific behavior and characterizations based on the happening of an event. For example, if Dr. Phil updates his web log (blog), the reference icon representing the blog of Dr. Phil may change to indicate that the blog has been updated with new information. If this reference icon shows the face of Dr. Phil, the face may be smiling to show new content has been added. Alternatively, there might be a symbol imposed near the reference icon of Dr Phil, perhaps even superimposed onto the reference icon, which indicates the blog has been updated.

In one embodiment, the location of a reference icon may change according to input from a third party. For example, if Dr. Phil updates his web log, the reference icon for his weblog may move closer to the focal point or move closer to the X-axis 17. In yet another example, if a number of friends of the user are visiting a certain web site, such as the CNN site, then the CNN reference icon may change or be marked to indicate the visits (perhaps with various happy faces around it), or the CNN icon may automatically move closer to the focal point, or alternately stay the same distance from the focal point but move closer to one of the axes. It is apparent that being closer or farther from one axis can have meaning - even if the distance from the focal point stays the same.

It should be appreciated that the user may also receive additional information related to the individual elements represented by the reference icon. For example, the user may select a specific reference icon (e.g., by double clicking on the specific reference icon, by rolling over the reference icon, by selecting to view the additional information from a selection on a view menu 6, by using eye tracking software, etc.) to display the additional information, such as a web page of a third party, a description of a book, a location of a meeting, a bio of a company officer, etc. The information provided after selecting the reference icon can come from a local or remote source, such as the Internet, a database, or from the local hard disk.

The user interface 5 allows a user to delete, insert, and modify a reference icon from the user interface 5. A user may delete or modify a reference icon 20-40 from a selection on an edit menu 4. Alternatively, a user may delete a reference icon by selecting the reference icon with the cursor and pressing the delete key. The user may insert or modify a reference icon from a selection on an insert menu 8, which will display a reference profile 300.

FIG. 3 illustrates one embodiment of a reference profile 300. The reference profile 300 includes fields to store reference information, such as a reference description field 310, a reference completion date/time field 320, a reference rating field 325, a reference image field 335, and a reference sound field 345.

The reference description field 310 stores a textual description associated with the individual element represented by the reference icon.

The reference completion date/time field 320 stores the completion date/time of a task. Furthermore, the reference completion date/time field 320 may be used by the user interface 5 to automatically position a reference icon relative to the focal point 10. For example, as the actual date/time gets closer to the scheduled completion date/time of a task, the user interface 5 may automatically reposition the related reference icon closer relative to the focal point 10.

The reference rating field 325 stores a rating associated with an individual element. The user interface 5 may use the rating to automatically position a reference icon relative to the focal point 10.

The reference image field 335 stores a name and location of an image associated with the individual element associated with the reference icon. For example, a user may associate an image (e.g., jpeg file, etc.) of her daughter playing soccer as a reminder to pick-up her daughter from soccer practice. The reference icons 20-40 may also include an image of the related representation, such as, pictures of food items to be bought, a cover of a book, a picture of a travel destination, faces and facial expressions, etc. The reference icons 20-40 may also include animation (e.g., waves hitting a beach of a travel location), a shortcut (or a link) to a file or another software application, short text (e.g., names, labels, etc.), data figures (e.g., sport scores, stock prices, etc.), etc. If the reference image field 335 is empty, the associated reference icon may display the text description contained in the reference description field 310.

The reference sound field 345 stores a name and location of a sound file associated with the reference icon. For example, a user may associate a sound file (e.g., mpeg, wav, etc.) of waves hitting the beach related to a travel destination. In this way, each reference icon may exhibit a unique behavior.

Upon creating a new reference icon, the user interface 5 may automatically position the reference icon based at least on the reference information in the reference completion date/time field 320 and/or the reference rating field 325. Alternatively, the new reference icon may be randomly positioned on the user interface 5, and the user may select the new reference icon and “drag and drop” it to a desired position on the user interface 5. It should be understood that the reference profile 300 is not limited to the fields described herein. Rather, the reference profile 300 may include additional fields, such as a file name field (e.g., to store the location of a digital file contain relevant information) and a uniform resource locator (e.g., a URL to store the Web location of a relevant web site), which are not disclosed herein so as not to obscure the invention.

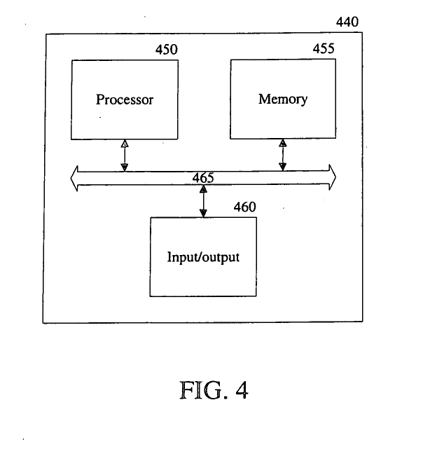

FIG. 4 illustrates one embodiment of a device suitable for performing the features of the user interface 5. The device 440 includes a processor 450, a memory 455, and an input/output capability 460, all coupled to a system bus 465. Such a configuration encompasses personal computer systems, network computers, television based systems, such as Web TVs or set-top boxes, handheld devices, such as mobile phones and personal digital assistants, and similar devices.

The processor 450 represents a central processing unit of any type of architecture, such as a CISC, RISC, VLIW, DSP, or hybrid architecture. In addition, the processor 450 could be implemented on one or more chips. The memory 455 is configured to store instructions which, when executed by the processor 450, perform the methods described herein. The memory 455 may also store the user information and the contact information.

Input/output 460 may include components to facilitate user interaction with the device 440 such as a keyboard, a mouse, an eye tracker, a display monitor, a microphone, a speaker, a display, a network card (e.g., Ethernet, Inferred, cable modem, Fax/Modem, etc.), etc. For example, input/output 460 provides for the display of the user interface 5 and reference profile 300 or portions or representations thereof. Input/output 460 also encompasses various types of machine-readable media, including any type of storage device that is accessible by the processor 450. For example, a machine-readable medium may include read only memory (“ROM”); random access memory (“RAM”); magnetic disk storage media; optical storage media; flash memory devices; electrical, optical, acoustical, or other forms of propagated signals (e.g., carrier waves, infrared signals, digital signals, etc.), etc. Thus, a machine-readable medium includes any mechanism that provides (i.e., stores and/or transmits) information in a form readable by a machine (e.g., a computer).

In addition, the bus 465 may represent one or more busses (e.g., PCI, ISA, X-Bus, EISA, VESA, etc.) and bridges (also termed as bus controllers). While this embodiment is described in relation to a single processor device, the invention could be implemented in a multi-processor device.

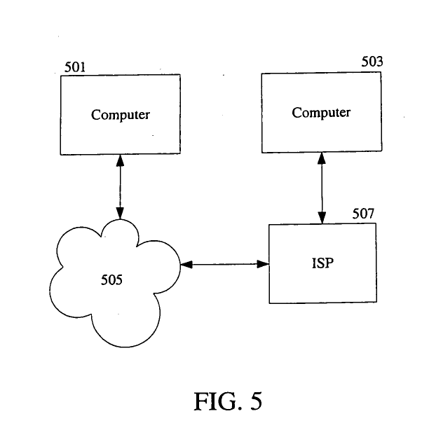

FIG. 5 illustrates a network environment suitable for the device illustrated in FIG. 4. In one embodiment, as shown in FIG. 5, a device 501 is part of, or coupled to a network 505, such as the Internet, to exchange data with another device 503, as either a client or a server device well known to those of ordinary skill in the art. For example, the device 501 may exchange individual elements of interest with device 503 as described herein. Typically, a device couples to the Internet through an ISP (Internet Service Provider) 507 and executes a conventional Internet browsing application to exchange data with a server. Other types of applications allow clients to exchange data through the network 505 without using a server. It is readily apparent that the present invention is not limited to use with the Internet. Directly coupled and private networks are also contemplated.

The description of FIG. 4 is intended to provide an overview of device hardware and other operating components suitable for implementing the invention, but is not intended to limit the applicable environments. It will be appreciated that the device 440 is one example of many possible systems that have different architectures. The invention can also be practiced in distributed environments where tasks are performed by remote processing devices that are linked through the network 505.

In addition, one of skill in the art will immediately appreciate that the invention can be practiced with other system configurations, including multiprocessor systems, minicomputers, mainframe computers, mobile device systems, television based systems, and the like. For example, the user interface 5 may be used to select television or cable program. The reference icons 20-40 may represent the available programs, either programs previously recorded or those programs being broadcast live. In one embodiment, the reference icons 20-40 representing each program can be displayed on a television screen and/or on a remote control having a screen (e.g., LCD screen). In one embodiment, the proximity of a reference icon to the focal point 10 can represent how popular the TV show is, how well the show has been rated, or how well the show matches a set of criteria established by the viewer or a third party. The proximity to the focal point can represent other factors as well.

It will be appreciated that more or fewer processes may be incorporated into the method illustrated in FIG. 2 without departing from the scope of the invention and that no particular order is implied by the arrangement of blocks shown and described herein. It further will be appreciated that the method described in conjunction with FIG. 2 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions, which may be used to program a computer (or other electronic devices) to perform the methods. For the purposes of this specification, the term “machine-readable medium” shall be taken to include any medium that is capable of storing or encoding a sequence of instructions for execution by the machine and that causes the machine to perform any one of the methodologies of the present invention. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or to produce a result.

Thus, a user interface having reference icons to visualize a set of individual elements of interest to a user has been described. As described, a predefined order may be associated with the individual elements of interest that are represented by the reference icons. However, it is understood that the invention is not limited to only those examples described herein. Rather, one of ordinary skill in the art will recognize that the user interface may visualize a set of individual elements having numerous predefined characteristics defined by a third party.

In addition, it should be understood that the invention is not limited to representing a focal point at the center of the user interface nor representing a significance of a reference icon by positioning the reference icon closer relative to the focal point. Rather, in an alternative embodiment, the focal point may be located anywhere on the user interface. Furthermore, in an alternative embodiment, the more significant reference icon may be positioned farther from the focal point.

While the invention has been described in terms of several embodiments, those skilled in the art will recognize that the invention is not limited to the embodiments described. The method and apparatus of the invention can be practiced with modification and alteration within the scope of the appended claims. The description is thus to be regarded as illustrative instead of limiting on the invention.

1. A device comprising:
a user interface comprising:
a point on the user interface; and
a reference icon representing an individual element, the reference icon being on the user interface, wherein the position of the reference icon relative to the point illustrates a significance of the reference icon to a user.

2. The device of claim 1, wherein the reference icon is one of a plurality of reference icons being radially positioned about the point, wherein the relative position of each reference icon relative to the point varies based on a positioning criteria.

3. The device of claim 1, further comprising:
a x-axis on the user interface, wherein the position of the reference icon relative to the x-axis illustrates a second significance of the reference to the user.

4. The device of claim 1, wherein the individual element represents a web page link.

5. The device of claim 4, wherein the user interface displays the web page associated with the reference icon upon the user selecting the reference icon.

6. The device of claim 4, wherein the reference icon is one of a plurality of reference icons associated with a plurality of ordered network search results.

7. The device of claim 1, wherein the relative position of the reference icon to the point varies automatically based on a positioning criteria.

8. The device of claim 7, wherein the user interface periodically repositions the reference icon based on the positioning criteria.

9. The device of claim 1, further comprising:
a reference profile to store reference information associated with the reference icon, wherein the reference profile is to be displayed upon selecting the reference icon.

10. The device of claim 1, wherein the reference icon is illustrated as a digital image associated with the individual element.

11. The device of claim 1, wherein the point is substantially at the center of the user interface.

12. A machine-readable medium having instructions to cause a machine to perform a method for visualizing individual elements, the method comprising:
displaying a point on a user interface; and
displaying one or more reference icons on the user interface, wherein the one or more reference icons represent one or more individual elements, wherein the one or more reference icons are positioned radially about the point, wherein each of the one or more reference icons are positioned on the user interface based on a significance related to each reference icon.

13. The machine-readable medium of claim 12, wherein the significance related to each reference icon is based on positioning criteria.

14. The machine-readable medium of claim 12, wherein the significance related to each reference icon is based on a rating order associated with the individual elements represented by each reference icon.

15. The machine-readable medium of claim 12, wherein the significance related to each reference icon is based on a listing order associated with the individual elements represented by each reference icon.

16. The machine-readable medium of claim 12, wherein the significance related to each reference icon is based on a time associated with the individual elements represented by each reference icon.

17. The machine-readable medium of claim 12, further comprising:
rearranging the position of the one or more reference icons based on a positioning criteria.

18. The machine-readable medium of claim 12, wherein the individual elements are web pages.

19. The machine-readable medium of claim 18, wherein displaying the reference icons further comprises:
positioning each reference icon based on a search result order, wherein the search result is ordered by relevancy, wherein the most relevant reference icon is positioned closer relative to the point.

20. The machine-readable medium of claim 18, further comprising:
selecting a first reference icon of the one or more reference icons; and
displaying the web page associated with the first reference icon.
